(19) United States
(12) Patent Application Publication
(10) Pub. No.: US 2012/0068413 A1
(43) Pub. Date: Mar. 22, 2012

(54) SEALING PROFILE

(75) Inventors: Georg PUTT, Grasellenbach (DE); Matthias MESSER, Wiesbaden (DE); Katrin KLEIN, Weinheim (DE)

(73) Assignee: CARL FREUDENBERG KG, Weinheim (DE)

(21) Appl. No.: 13/227,087

(22) Filed: Sep. 7, 2011

(30) Foreign Application Priority Data
Sep. 17, 2010 (DE) 102010045671.3

(51) Int. Cl. F16J 15/32

(52) U.S. Cl. 277/306; 277/361

(57) ABSTRACT

A sealing arrangement comprising first and second machine elements which can turn relative to one another and delimit an installation space to be sealed for a sealing ring. The sealing ring has at least one static sealing area, which is connected, in a form-locking manner, by an anchoring bead, with a congruently shaped first indentation in the first machine element. The sealing ring has at least one dynamic sealing area with at least one first sealing lip that touches a first undercut of the second machine element with a sealing effect. The dynamic sealing area has at least one second sealing lip, which is connected with the first sealing lip by a connecting piece.

### FIELD OF THE INVENTION

The invention concerns a sealing arrangement comprising first and second machine elements which can be turned relative to one another and delimit an installation space for a sealing ring in which the sealing ring is placed so as to provide a sealing effect within the installation space. The sealing ring has at least one static sealing area, which is connected by a first anchoring bead to a congruently shaped first indentation in the first machine element in a form-locking manner. The sealing ring has at least one dynamic sealing area with at least one first sealing lip, which touches, with a sealing effect, a first undercut of the second machine element, which extends in the radial direction. The sealing ring has at least one second sealing lip, which is connected by a connecting piece to the first sealing lip. The second sealing lip touches, with a sealing effect, a sealing surface of the first machine element. The sealing lips and the connecting piece essentially have the shape of an anchor.

### BACKGROUND OF THE INVENTION

A sealing arrangement such as described above is disclosed in WO2009/149810A1. This sealing system is used to seal off large-size rolling bearings, which are used, in particular, in wind power plants. The static sealing area has only one first anchoring bead, which is placed, in a form-locking manner, in a congruently shaped first indentation in the first machine element. On the opposite side of the first anchoring bead, in the radial direction, the static sealing area has two sealing lips, which are adjacently correlated with one another at an axial distance, and which closely touch the surface to be sealed, under a radial elastic biasing tension. Correspondingly, the second sealing lip touches the sealing surface of the first machine element. The sealing surface extends, flat, in the axial direction.

### SUMMARY OF THE INVENTION

An object of the invention is to further develop a sealing arrangement of the previously known type in such a way that substantially higher pressures can be reliably sealed and that the sealing ring also has good dimensional stability, even with large diameters.

To this end, provision is made so that the static sealing area also has a second anchoring bead, which is connected in a form-locking manner to a congruently shaped second indentation in the first machine element, and so that the sealing surface has a second undercut, which extends in the radial direction and on which the second sealing lip can be placed with a sealing effect.

By means of these measures, it is possible for the sealing arrangement to reliably seal off not only approximately 4 bar. It is also possible for excess pressures in the installation space in the area of 10 bar to be reliably sealed without the seal being pressed out of its installation space by the particularly durable arrangement of the sealing ring. Both the first and the second anchoring beads are placed, in a form-locking manner, in the installation space, as well as the first and the second sealing lips, which are kept in their position, in a form-locking manner, by the first and the second undercuts, even at high pressures. Furthermore, in this way, a tilting of the sealing ring in its installation space is prevented.

It is advantageous that the sealing ring have good dimensional stability due to its reliable affixing in the installation space—even when high pressures in the area of approximately 10 bar have to be sealed and/or the sealing ring has a large diameter. A large diameter is understood to mean, in this case, diameters which are up to 4 m. Such large diameters are used to seal off blade bearings in slewing rings of wind turbines. With the good dimensional stability, moreover, it is possible to more easily cover larger tolerances of the machine elements which delimit the installation space.

According to an advantageous development, it is possible to make provision so that the first anchoring bead with the corresponding first indentation and the second anchoring bead with the corresponding second indentation are placed on radially opposing sides of the static sealing area. In this way, a reliable and tilt-proof affixing of the static sealing area in the installation space is ensured.

In order to simplify the assembly of the static sealing area in the installation space, the first and the second anchoring beads and the congruently shaped indentations are preferably arranged staggered with respect to one another in the axial direction. If the anchoring beads were arranged, axially, in a radial plane, without staggering them with respect to one another, the assembly of the static sealing area in the installation space would be substantially more difficult, because, during the assembly, there would be the danger that the anchoring beads would be deformed to an impermissibly large degree. This would raise the risk that the anchoring beads are damaged during assembly.

The sealing ring is preferably designed as one piece and uniform in its material. Such sealing rings are produced simply and at low cost and are very suitable for most applications.

The sealing ring can have another dynamically stressed third sealing lip, which is arranged on the side of the first sealing lip, turned away, axially, from the installation space to be sealed. In addition to the first and the second sealing lips, this third sealing lip ensures that impurities from the surroundings are kept away from the space to be sealed, and that the medium to be sealed does not get out from the space to be sealed, past the sealing ring and into the surroundings.

The first machine element can be formed by a bearing outer ring or a bearing inner ring and the second machine element by a bearing inner ring or a bearing outer ring of a rolling bearing. In such a case, the sealing ring seals off the interior of the rolling bearing and the surroundings of the rolling bearing with respect to one another. The anchor, consisting of the two sealing lips and the connecting piece, is locked behind an undercut by its two sealing lips and arranged in the interior of the rolling bearing. The sealing arrangement can be used in slewing rings of wind turbines, wherein the rolling bearings form the bearing of the blades, which are held in the slewing rings, which can swivel around their longitudinal axis.

An exemplary embodiment is explained in more detail below with the aid of FIG. 1.

### BRIEF DESCRIPTION OF THE DRAWING

FIG. 1 is a schematic cross-sectional view of an exemplary sealing arrangement in accordance with the invention.

### DETAILED DESCRIPTION OF THE PREFERRED EMBODIMENTS

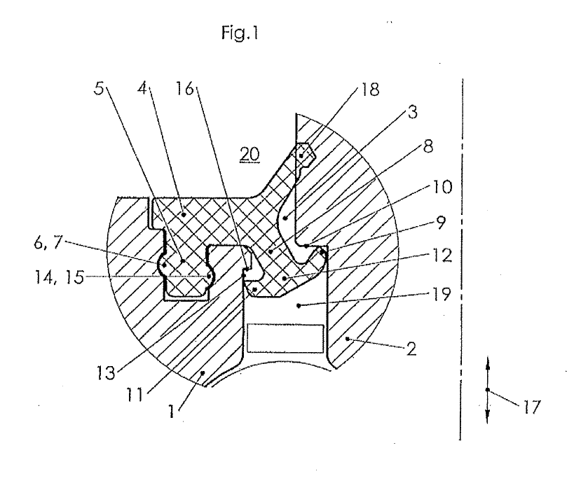

Referring to FIG. 1, the sealing ring (4), which is designed as one piece and is uniform in its material, is placed within the installation space (3). The installation space (3) is delimited by the two machine elements (1, 2), which can turn, relative to one another. The first machine element (1) is formed, in the illustrated embodiment, by a bearing outer ring of a rolling bearing, and the second machine element (2) by a bearing inner ring of the rolling bearing.

The sealing ring (4) is placed, in a form-locking manner, in the installation space (3), both with its static sealing area (5) and with its dynamic sealing area (8). The form-locking grip of the static sealing area (5) is brought about by the first (6) and second anchoring beads (14), which are each placed in congruently shaped indentations (7, 15) of the first machine element (1). The anchoring beads (6, 14) are arranged staggered in the axial direction (17), on radially opposite sides of the static sealing area (5), so that the static sealing area (5) can be assembled more simply in the installation space (3).

The dynamic sealing area (8) is likewise gripped, in a form-locking manner, in the installation space (3) by the first sealing lip (9) and the second sealing lip (11). The two sealing lips (9, 11) are connected with one another by the connecting piece (12).

The following is a description of the operation of the sealing arrangement. The sealing ring (4), incorporated between the two machine elements (1, 2) in the installation space (3), provides for the lubricant to be retained within the space (19) to be sealed, while it is being used properly and it does not go past the sealing ring (4) into the surroundings (20)—even if relative excess pressures in the area of 10 bar are to be sealed within the space (19) to be sealed. If excess pressures prevail within the space (19) to be sealed, relative to the surroundings (20), this excess pressure acts on the anchor, which consists of the two sealing lips (9, 11) and the connecting piece (12). The anchor is pressed in the direction of the surroundings (20) as a result of the excess pressure and is spread due to the shape of the anchor, and the two sealing lips (9, 11) fit against the individual undercuts (10, 16) of the second machine element (2) and the first machine element (1). This form closure, together with the form closure of the static sealing area (5) on the first machine element (1), provides that the sealing ring (4) is not pressed out of its installation space (3) into the surroundings (20), even if excess pressures of, for example, 10 bar, are to be sealed within the space (19) to be sealed.

The third sealing lip (18) mainly provides for impurities to not be able to penetrate from the surroundings (20) into the installation space (3) and into the space (19) to be sealed. In the drawing, the cover of the third sealing lip (18) for the corresponding area of the second machine element (2) to be sealed is shown.

1. A sealing arrangement comprising:
first and second machine elements which can turn relative to one another and delimit an installation space to be sealed for a sealing ring;
the sealing ring being placed with a sealing effect within the installation space;
the sealing ring having at least one static sealing area that is connected in a form-locking manner by a first anchoring bead with a congruently shaped first indentation in the first machine element;
the sealing ring having at least one dynamic sealing area, the dynamic sealing area having at least one first sealing lip that touches with a sealing effect a first undercut of the second machine element that extends in a radial direction and the dynamic sealing area having at least one second sealing lip that is connected by a connecting piece with the first sealing lip, the second sealing lip touching with a sealing effect a sealing surface of the first machine element, the first and second sealing lips and the connecting piece being substantially in the shape of an anchor;
wherein the static sealing area has a second anchoring bead that is connected in a form-locking manner with a congruently shaped second indentation in the first machine element and that the sealing surface has a second undercut that extends in a radial direction and on which the second sealing lip can be placed with a sealing effect.

2. The sealing arrangement according to claim 1, wherein the first anchoring bead with the corresponding first indentation and the second anchoring bead with the corresponding second indentation are arranged on radially opposite sides of the static sealing area.

3. The sealing arrangement according to claim 1, wherein the first and the second anchoring beads and the congruently shaped indentations are arranged staggered with respect to one another in an axial direction.

4. The sealing arrangement according to claim 1, wherein the sealing ring is consists of one piece and is uniform in its material.

5. The sealing arrangement according to claim 1, wherein the sealing ring has a dynamically stressed third sealing lip that is arranged on the same side as the first sealing lip, the third sealing lip being turned away, axially, from the space to be sealed.

6. The sealing arrangement according to claim 1, wherein the first machine element is formed by a bearing outer ring or a bearing inner ring and the second machine element by a bearing inner ring or a bearing outer ring of a rolling bearing.

7. A method for sealing slewing rings of wind turbines using the sealing arrangement according to claim 1.
